(19) United States
(12) Patent Application Publication
(10) Pub. No.: US 2004/0039750 A1
(43) Pub. Date: Feb. 26, 2004

(54) Computer publication

(76) Inventors: Chris Nathan Anderson, Surry Hills (AU); Colin Craig Fabig, Neutral Ray (AU); David De Fracneschi, (US)

Correspondence Address: WILDMAN, HARROLD, ALLEN & DIXON, 225 WEST WACKER DRIVE, CHICAGO, IL, 60606, US

(21) Appl. No.: 10/363,302

(22) PCT Filed: Mar. 15, 2001
(86) PCT No.: PCT/AU01/00287

(30) Foreign Application Priority Data
Aug. 31, 2000 (AU) 5507200

(51) Int. Cl. G06F 17/00

(52) U.S. Cl. 707/103 R

(57) ABSTRACT

The present invention relates to a computer publication and provides a computer publication in the form of a virtual book, magazine or catalogue. The publication appears on the computer screen with the “look and feel” of a real-life publication. The publication has pages which can be turned (appearing as an animation on the computer screen) and the publication can be manipulated with the appearance of being manipulated in three dimensions.

### FIELD OF INVENTION

The present invention relates to publications which are arranged to be accessed and read by way of a computing system and particularly, but not exclusively, to publications which are arranged to be distributed via computer networks.

### BACKGROUND OF INVENTION

Publications, such as books, newspapers, periodicals, magazines, catalogues and others have been well known for many years, and have proven their suitability and convenience for the dissemination of published material. It is considered that computers may also provide a convenient method for the distribution of published material software packages are available which enable presentation of documents. These include word processing packages (to which published documents can be downloaded to be read). They also include graphic formats, such as PDF, which can enable presentation of images. E-readers are also known. These comprise a reader program, which can read downloadable files (e-books). The published content of the file is usually presented A4 format, with an interface which enables scrolling.

None of the presently available formats for computer publications, however, appear to be completely satisfactory and computer publication has still not proved to be an acceptable replacement for conventional means of publication.

It is believed by the applicants that the reason for this may be that the formats presently available for computer publications are not “user-friendly”. For example, with word processing packages and PDF, the user is usually presented with a full screen of text or image which they must scroll. The text or image can be cumbersome to navigate and tiring to read, particularly for any length of time. People find the conventional publication formats (books, newspapers, calendars, magazines, etc) to be “easier” to handle and less tiring to read.

It is known to provide “reader” programs to which a user can download content. Pages are usually in the form as discussed above, i.e. full screen pages. The problem with such arrangements is that the user requires the reader program before they can read content. Further, again these types of packages are not as user friendly as “real-world” hard copy publications.

### SUMMARY OF INVENTION

The present invention provides a computer generated publication, comprising a virtual publication artefact generated by computer and presented on a computer display, the virtual publication artefact being arranged to resemble a real publication artefact, and publication interface means enabling manipulation of the virtual publication artefact in a manner representative of manipulation of the real publication artefact.

The virtual publication artefact preferably resembles a real publication artefact at least in the sense that it has “virtual pages” which resemble real pages of a real publication artefact (e.g. book). The virtual publication artefact may have more features that make it resemble even more closely the real publication artefact. For example, a book may have a cover, it may be presented in a three-dimensional form on a computer screen looking like a real book, that can be opened, in which the pages can be turned and preferably bent, and which can be manipulated about the computer display screen. Audio outputs may also be generated by the computer which resemble sound which occur when the corresponding real-life publication is being manipulated. For example, a virtual newspaper may appear to make a rustling sound when it is manipulated on the computer display. When the pages of a virtual book are turned the computer may generate a page-turning sound.

Preferably, the virtual publication artefact is a virtual book (note that in this specification the term “book” includes any book-like publication, such as hardcover book, soft-cover book, brochures, photo albums, newsletters, newspapers, calendars, magazines and catalogues).

The virtual book preferably includes virtual pages which appear on the computer display resembling the pages of an actual book. The virtual book preferably has the “look and feel” of a real book.

The publication interface means preferably includes interface means which are arranged to enable the pages of the book to be turned. The publication interface means preferably includes a graphical user interface and buttons provided on each page are actuated to cause the pages to turn. Other buttons preferably carry out other functions, as will become apparent from the following description.

The virtual book is preferably arranged so that at least one full page of virtual book can be displayed at a time on the computer screen. More preferably, two full pages (one page opposite the other page) are displayed on the computer display.

Preferably, two full pages are displayed on the computer display, and are moveable via the interface means from right to left and left to right, in appearance resembling the turning of the pages of a real book.

When a page is turned, preferably the “look and feel” of a real page turning is given. The page appears on the computer screen to roll or turn as a real page would turn and preferably an audio output (e.g. a page flipping sound) from the computer is given of a page being turned over.

Preferably, the pages of the virtual book appear to have a three-dimensional contour, and images or virtual printed matter on the pages are arranged to appear to conform with the contour.

Preferably, each side of the book may appear to get thinner or thicker, depending upon how many pages have been turned, much in the same way as a real book.

Preferably, the publication interface means includes an interface means arranged to open or close the virtual book. The virtual book is preferably arranged to appear as a three-dimensional article on the computer screen and it can preferably be “turned around” so that the back of the virtual book appears on the screen or the spine of the virtual book appears presented on the display. The virtual book may also be manipulated and moved about the computer display (e.g. moved about the desktop).

Preferably, the book cover is arranged to appear contoured. Preferably, images or printed matter on the book cover are arranged to appear to conform with contours of the book cover.

The virtual pages may include text having the appearance of printed matter, and images. The images may be animated and may leave the pages of the book to appear elsewhere on the computer display. Audio output is preferably associated with manipulation of the book and may accompany some of the images and motion of the animated images.

Preferably, a virtual book mark is provided which can be manipulated by the publication interface means to mark a virtual page which the user may wish to return to at a later stage.

The virtual publication preferably includes an index and link means are preferably provided that enable a link between any item of the index and the page where the item appears. Preferably, when the link is activated (e.g. by mouse click) the virtual publication jumps to the page where the indexed item appears.

The publication may also include link means for linking to locations on a computer network, such as Web pages (this may enable e-commerce).

Link means are also preferably provided to enable a user to download part or all of a book for payment, or to order a real book version of the virtual book. Links may also be included to Web based search engines.

There may also be links to other documents and programs on the computing device which the virtual publication artefact is being presented on.

Security means are preferably provided for restricting operation of the virtual publication artefact to a predetermined computing device so that the publication artefact cannot be copied to another device without authorisation.

The computer publication is preferably generated by an executable program operating on the computer system. The executable program is preferably downloadable over a computer network.

The executable program preferably operates by opening a window on the computer desktop. The window is preferably irregular in outline (which is novel) to resemble the publication artefact such as a virtual book. The virtual publication is not merely a graphic, but preferably a program which executes as a window on a computer display desktop. The window can preferably be minimised and maximised and can preferably be moved around on the desktop. It is preferably smaller in size than the computer desktop. Unlike the prior art e-books, the virtual publication of the present invention is preferably not a downloadable file which is read by a separate program, but is a program itself which executes as the virtual publication and includes the publication interface means.

As an alternative to the computer publication being an executable program, it could be on-line downloaded from the Internet via a browser. For example, as pages of the virtual book are turned, the next page is downloaded by the browser to appear as if it is the next page in a real book.

In the preferred embodiment the virtual book appears on a computer display having the “look and feel” of a real three-dimensional book. It can be manipulated on the computer display (as if it is being manipulated in space) and it can be opened and closed and the pages can be turned.

It has been found, surprisingly, that presenting a publication in this manner on a computer display is more “user friendly” than typical computer document interfaces or e-book readers. This may be because people are familiar with books, newspapers and the like, and are therefore used to this type of presentation. As the publication on the computer screen resembles the “real-life” interface they are used to, and can be manipulated in a similar manner, users appear more “at ease” with the publication, even though it is still presented on a computer display. Importantly, in the preferred embodiment, an entire page, preferably two entire pages, are presented on the computer display at the same time. The user can thus scan and read an entire page or pages, without scrolling.

As well as a virtual book, a virtual publication artefact may be any type of publication, preferably resembling a real publication. For example, it may be a postcard, which can preferably be manipulated about the computer desktop in a “three-dimensional” form, so that it can be turn so as the back and the front can be seen. It may be a letter in an envelope, the virtual letter being manipulatable and being able to be taken out of and put back into the envelope. The virtual publication may be a virtual pamphlet or a virtual flier. Pamphlets and fliers may be foldable and can be manipulated so that they can be unfolded. They may just have a single page and can be manipulated on the computer desktop as if they are three-dimensional. The virtual publication may be a virtual invite.

Preferably, as discussed above the virtual publications are executable programs or programs which may be downloaded over the Internet and include the virtual publication interface. They are not merely graphical representations. The virtual publication is, in a sense, with a program.

Other virtual publication artefacts may include virtual business cards, virtual greeting cards, virtual binders with file contents, and any other real publication media which can be generated in this form as a virtual publication artefact.

The present invention further provides a computing system including means arranged to generate a computer generated publication as discussed above.

The computing system may include any appropriate hardware and software to produce the virtual publication. It may include a stand-alone PC, for example, a networked system or any available architecture. The computing system may be a small computing device such as a palm-type computer, or a specially designed reader for generating the virtual publications.

The present invention further provides a computer readable medium, including instructions for controlling a computing system to generate a computer generated publication as discussed above.

The computer readable media may include CD ROMs or any other machine readable media, including transmission media, such as cabling, fibre optics or any other forms of transmission media.

The present invention further provides a method of providing published material via a computer, comprising the steps of generating a computer generated publication as discussed above.

The present invention further provides a method of distributing published material, comprising the steps of enabling the provision of a computer generated publication as discussed above to a user computer over a computer network.

The provision of the computer generated publication may be achieved by means of transmitting software over the network to the user computer which, when it runs on the user computer, causes the user computer to generate the computer generated publication.

Alternatively, the computer generated publication may be generated via a browser, portion by portion, as discussed above.

In one method of distributing the published material, the computer generated publication is provided to the user including only a portion of the full publication. This acts as a “teaser” or sample which the user can view. If the user then wishes to obtain the entire publication they can download the entire publication, perhaps for payment. As an alternative to downloading the entire computer generated publication, in one embodiment the user may choose to be provided with the real publication, in the form of a real publication artefact (e.g. a real book) which is represented by the virtual publication artefact.

Catalogues are a well-known way of marketing products/services. Catalogues are often distributed free or at a low cost to a membership or to the public and users can select from a choice of products (either goods or services) available, and order. Order may be by mail or e-mail or otherwise. One problem with catalogues is that they are expensive to print and distribute. This makes the business process of the distribution of catalogues in order to sell product quite an expensive one.

In accordance with a further aspect of the present invention, there is provided a method of distributing information on products for sale to users, comprising the steps of distributing a virtual publication including content providing information on products for sale, via a computer network to user terminals.

Preferably, the virtual publication is a downloadable executable which can be downloaded to a user terminal and executed on a user terminal to produce the virtual publication.

Preferably, the virtual publication is a virtual publication having any or all of the features of the virtual publication discussed above in relation to the earlier aspects of the present invention, being in the form of a product catalogue.

Preferably, the virtual publication includes means enabling a user to order product via the computer network. The means may be an order form, or a link to an Internet site where an order for a product can be placed.

Preferably, providing the catalogue with the “look and feel” of a real-life catalogue will make the business process more “user friendly”. Further, catalogues provided as virtual publications are far cheaper to produce than real-life printed catalogues.

In accordance with a further aspect of the present invention, there is provided a virtual publication distributable to user computers and comprising an executable program, wherein the content of the virtual publication and the virtual publication are provided by the same program.

The virtual publication is therefore provided as a single “package”. Nothing further is required to run the virtual publication and the content than, for example, a conventional PC.

An advantage of having a virtual publication as a downloadable executable is that no separate reader is required. Further, the executable is a self-contained package and can be broadcast or carried on computer readable media such as disc to any location and be operational when it reaches that location.

The virtual publication is preferably in the form discussed in relation to the earlier aspects of the invention discussed above.

From yet a further aspect, the present invention provides a method of disseminating information comprising the steps of providing a plurality of virtual publications in the form of executables, downloadable via a computer network or distributable via computer readable media, each executable including the information content and data enabling the information content to be read in the form of a virtual publication, in the single executable.

### BRIEF DESCRIPTION OF DRAWINGS

Features and advantages of the present invention will become apparent from the following description of embodiments thereof, by way of example only, with reference to the accompanying drawings, in which;

FIG. 1 is a schematic diagram of a computer system suitable for generating a virtual publication artefact in accordance with an embodiment of the present invention;

FIGS. 2A, 2B and 2C show an embodiment of a computer generated publication in accordance with the present invention, to illustrate how the publication may be manipulated in virtual space;

FIG. 3 shows a computer generated publication in accordance with the present invention, illustrating images on open pages; of the publication artefact;

FIG. 4 shows a further embodiment of a computer generated publication in accordance with the present invention, to illustrate various operational features of the computer generated publication;

FIG. 5 shows a further embodiment of a computer generated publication in accordance with the present invention, illustrating a book marking feature;

FIG. 6 shows a further embodiment of a computer generated publication in accordance with the present invention, illustrating a search and ordering function;

FIG. 7 is an illustration of the Web search function of a computer generated publication in accordance with an embodiment of the present invention;

FIG. 8 and FIG. 9 show different formats of computer generated publication in accordance with embodiments of the present invention;

FIG. 10A and FIG. 10B show a computer generated publication in accordance with an embodiment of the invention including an animation feature;

FIG. 11 shows an embodiment of a different format of computer generated publication from that of FIG. 10, also showing an animation feature;

FIG. 12 shows a large format embodiment of a computer generated publication of the present invention;

FIG. 13 shows further embodiment of a computer generated publication of the present invention;

FIG. 14 shows a page turning animation of a computer generated publication in accordance with an embodiment of the present invention;

FIGS. 15A and B are further embodiments of a computer generated publication illustrating an indexing feature;

FIGS. 16 and 17 show a further embodiment of a computer generated publication, in this embodiment being a virtual magazine;

FIGS. 18 and 19 show further embodiment of a computer generated publication in accordance with this invention, in this embodiment being a virtual catalogue;

FIGS. 20 through 23 illustrate an alternative embodiment of a virtual catalogue, showing interfaces providing information and enabling ordering of products;

FIGS. 24 and 25 illustrate an embodiment of a virtual magazine, and

FIG. 26 illustrates an embodiment of the invention in the form of virtual paper.

### DESCRIPTION OF PREFERRED EMBODIMENT

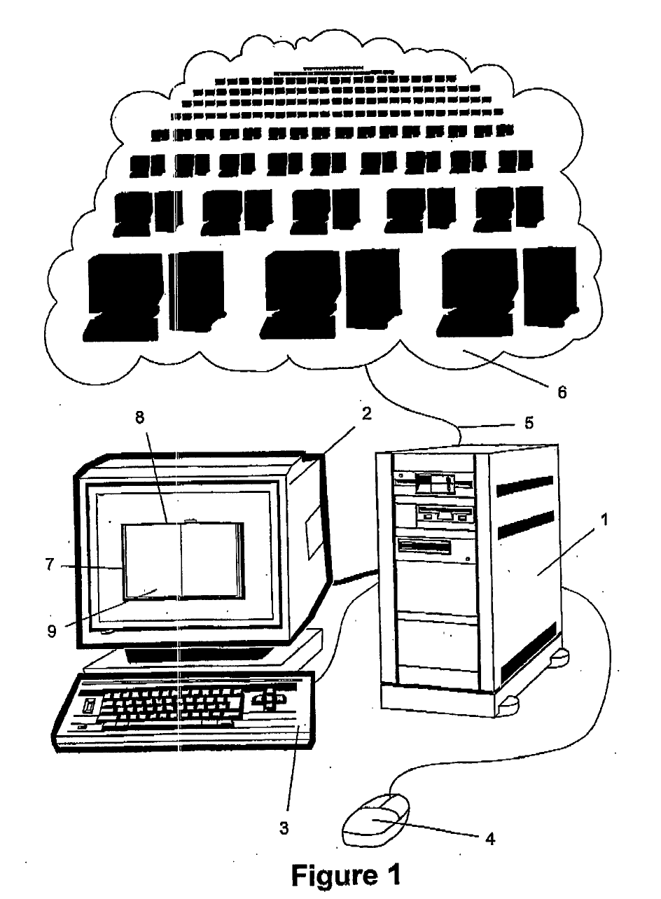

FIG. 1 is a schematic diagram of a computer system which is suitable for generating a computer generated publication in accordance with an embodiment of the present invention. The computer system in this case comprises a personal computer (PC) 1, having a computer display, in this example computer monitor 2 and a computer interface including a keyboard 3 and mouse 4. The PC may be any type of suitable PC. PC 1 may include a Modem (not shown) and a line connection 5 to a public access computer network such as the Internet 6.

Note that any suitable computer system can be used to generate the computer generated publication in accordance with the present invention and not only a standard PC. All that is required is a suitable amount of processing power, a display and an interface. Any suitable architecture could be utilised, including networked architecture or mainframe architecture. Similarly, “compact” computer systems could also generate the computer generated publication, including laptop and palmtop computing systems. The computer generated publication could also be generated by a WAP enabled device.

Shown illustrated on the computer monitor 2 is a computer generated publication in accordance with an embodiment of the present invention in the form of a virtual publication artefact 7. In this embodiment, the virtual publication artefact 7 is a virtual book 7 and, (as will become clear later on with reference to the other drawings), resembles a real book and has a cover 8 which can be opened as shown in FIG. 1 and pages 9. The virtual book 7 appears within “virtual space” on the display 2. It can be seen from FIG. 1 that it does not take up the entire space of the monitor, in this preferred embodiment, and that at least one page (in this embodiment two pages) of the virtual book 7 can be seen at any time. This is unlike the presently known computer publication interfaces, where, usually, only a part of text to be read can be seen at any one time and to see further text a user must scroll, or publication pages are represented as single A4 pages taking up the majority of the space on the computer desktop. Conventional computer publications are in fact uncomfortable for many people to read, for any length of time. On the other hand, the virtual book 7 of the embodiment illustrated in FIG. 1 has been found to be very comfortable to read, as it resembles the real-life article, at least in so much as it has a cover 8 and pages 9 which can be turned via a publication interface means (which in the preferred embodiment includes buttons of a GUI, appearing on the virtual publication artefact, which can be mouse clicked to cause the pages to turn).

As well as having cover 8 and pages 9, the virtual book 7 may have many other features to make it even more closely resemble a real book, and some computer enabled features to take advantage of computer facilities, as will be described in the following.

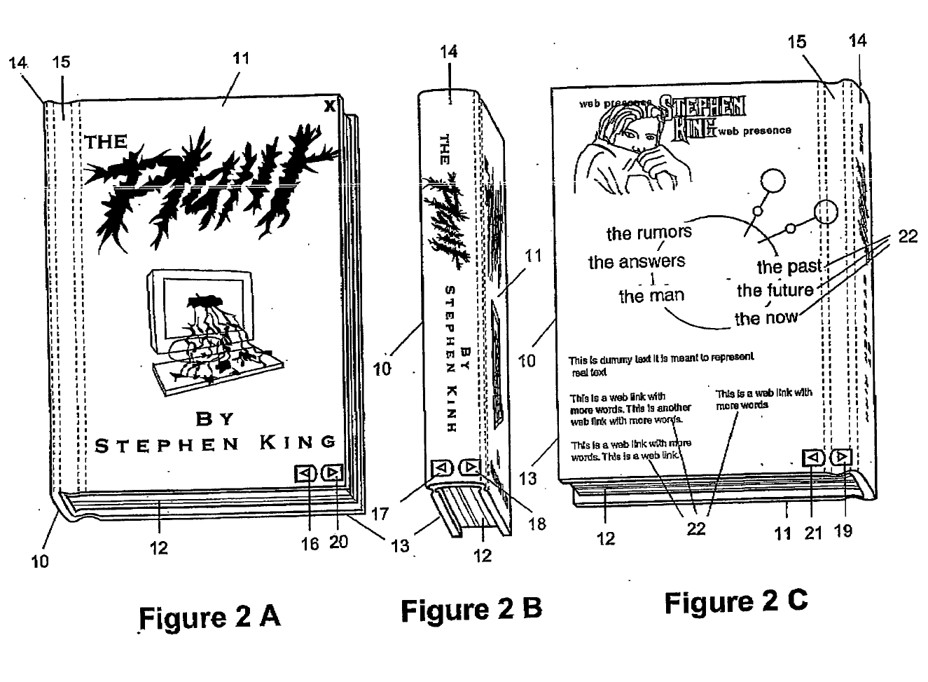

FIG. 2A shows an example virtual book 10 as it would appear on a computer display before being “opened”. FIG. 2A shows the front cover 11 of the virtual book 10. The book is also provided with a three-dimensional “look” and pages 12 can be seen in a three-dimensional manner and also the rear cover of the book 13. This is also because the virtual book 10 is smaller than the computer desktop and is not surrounded by any conventional software “window”. In fact, the virtual book is itself an irregularly shaped window which therefore appears with a three-dimensional look. It will be noted that the style of this virtual book is a “hard back”, as the cover 11, 13 appears to be a hard back cover. The book 10 also has a spine 14. Virtual book 10 appears to be contoured at reference numeral 15 adjacent the spine, again to more nearly resemble a real-life book.

Note that the virtual book, when opened, may be smaller than the computer desktop or may take up the entire computer desktop, or may be larger.

Generally, a hard cover book appears with more straight lines and a soft cover book or magazine appears with more bent lines. Further, in a magazine or soft cover book, the contours would be softer and thinner on the spine.

The virtual book 10, when closed, can be manipulated in “virtual space” (i.e. manipulated about the computer display). An interface in the form of GUI buttons is used to manipulate the book 10 in virtual space. Button 16 when clicked turns the book 10 so the spine 14 faces outwardly of the screen, towards the user. Buttons 17 and 18 on the spine turn the book so that the back faces outwardly (FIG. 2C) or the front faces outwardly of the screen (FIG. 2A), respectively. Button 19 on the back face 13 of the book 10, when clicked turns the book back towards the spine 14 view (FIG. 2B). Button 20 on the front cover 11 opens the book at the front (see later). Button 21 on the back cover 13 of the book 10 opens the book to the back page.

In addition to these “real life” book features the computer generated publication may also make use of facilities available to it by way of the computer. On the back cover 13 of the virtual book 10 shown in FIG. 2, for example, is an interface including a number of links 22 to Web sites so that the user can click on these links and their browser can download the linked Web pages from the Internet.

Further, the virtual book 10 may be “dragged” about the computer display 1 by mouse clicking on any part of the book 10 and moving the cursor with the book 10 following. Further, the book can be reduced to an icon on the desktop by clicking on an appropriate control button (not shown).

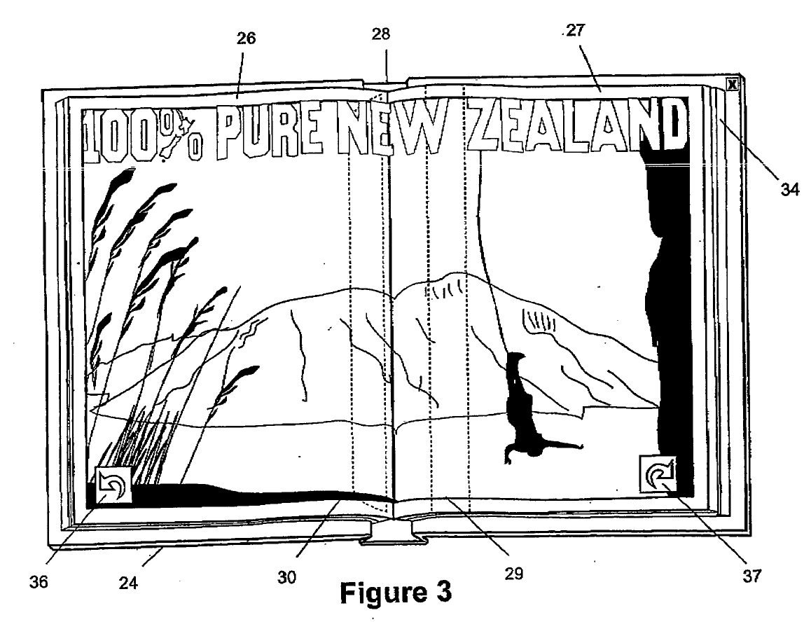

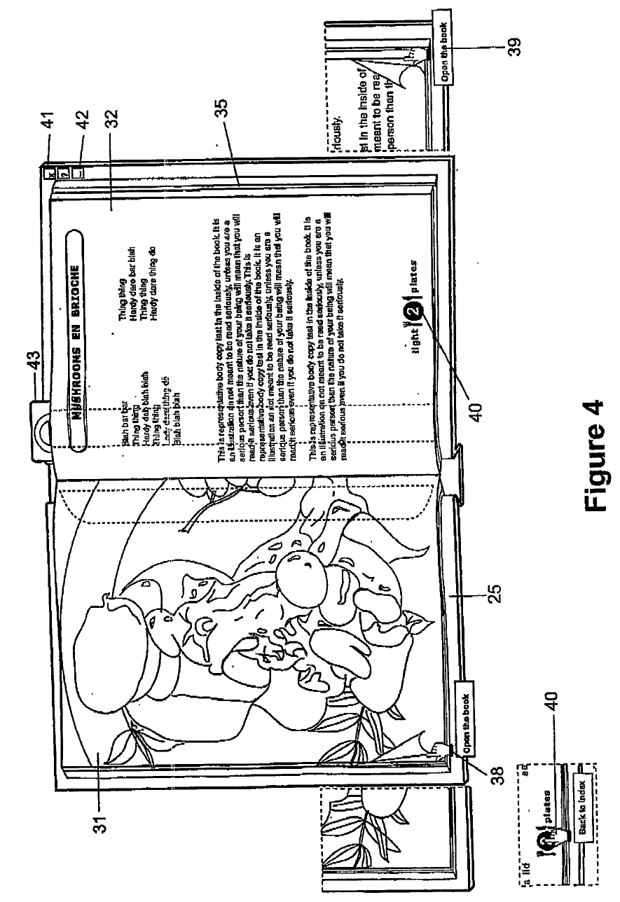

Referring now to FIGS. 3 and 4, each of these show a different embodiment of virtual book 24 (FIG. 3) and 25 (FIG. 4). In FIG. 3, the book has been opened to show virtual pages 26 and 27 (among the plurality of pages which can be turned to in the virtual book 24). It can be seen that in this embodiment two full pages 26 and 27 of the virtual book 24 are displayed at a time. This is a similar view to a user reading a real book (where he sees two full pages at any time). Note that in alternative embodiments one full page may be shown only. Preferably, however, two full pages are shown as illustrated in FIG. 3. In the example of FIG. 3, the pages 26 and 27 show an image and the image is presented with a three-dimensional “look and feel”. In particular, towards the spine 28 of the virtual book 24, the pages follow a curved contour (indicated by arrows 29 and 30) and the image itself is curved to follow the contour, so as to give the impression of real pages. This is achieved graphically by appropriate shading of the various parts of the image to give the impression of contouring.

This contouring effect is also shown by the pages 31 and 32 shown open in FIG. 4.

To enhance the three-dimensional effect, the edges 34 (of FIG. 3) and 35 (of FIG. 4) show the appearance of depth and multiple pages behind the open pages.

GUI buttons are used to turn the pages of the books of FIGS. 3 and 4. In FIG. 3, the buttons are clearly shown, reference numerals 36 and 37 of the bottom corners of the pages 26 and 27. In FIG. 4, no buttons are shown but when the mouse cursor is passed over the right part of the page (bottom corners) a “hand” icon appears indicating that a mouse click will cause a page to turn. See reference numerals 38 and 39. It will be appreciated that the buttons may be placed in a number of locations or that other interface means could be utilised to turn the pages (e.g. key strokes on a keypad, a click and drag on a mouse).

In addition, referring to FIG. 4, this virtual book 25 includes an index (not shown in the FIG. 4 diagram). The index includes a list of entries relating to the contents of the book. Clicking on one of the entries causes the book to open at the page corresponding to the linked index entry. Further, a button 40 is provided at the bottom of each page 32 which, when clicked, returns the book to the index.

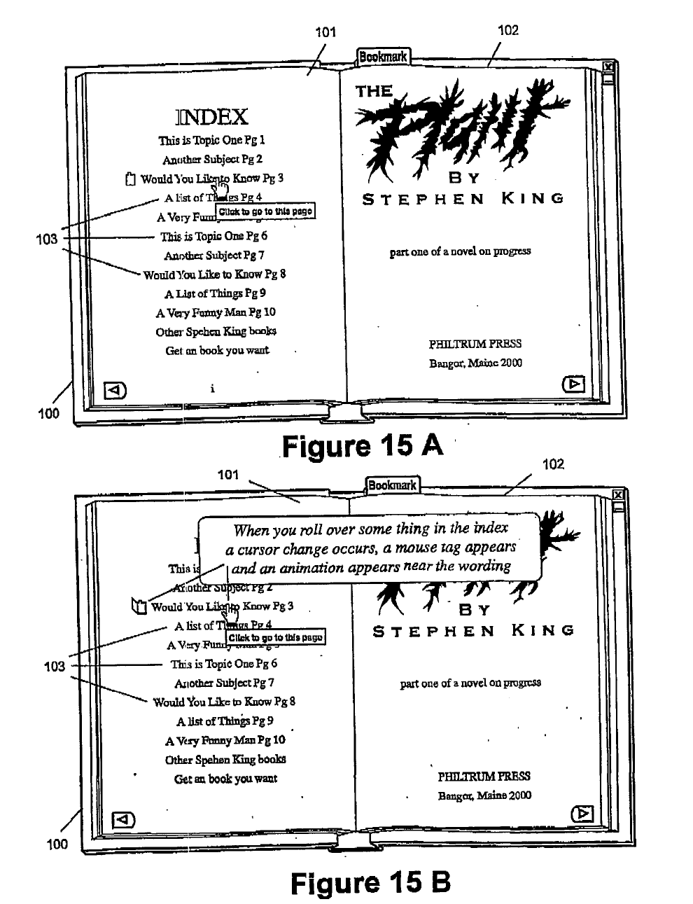

FIGS. 15A and 15B show a further virtual book 100 open at pages 101, 102 where page 101 shows an index interface. Clicking on any one of the links 103 in the index causes the book to open at the page corresponding to the index item. When the cursor is rolled over an item 103 in the index, a cursor change occurs to a hand icon and an animation appears adjacent the index item.

Referring again to FIG. 4, the book can be closed to an icon (button 41) or minimised (button 42) just like any other program.

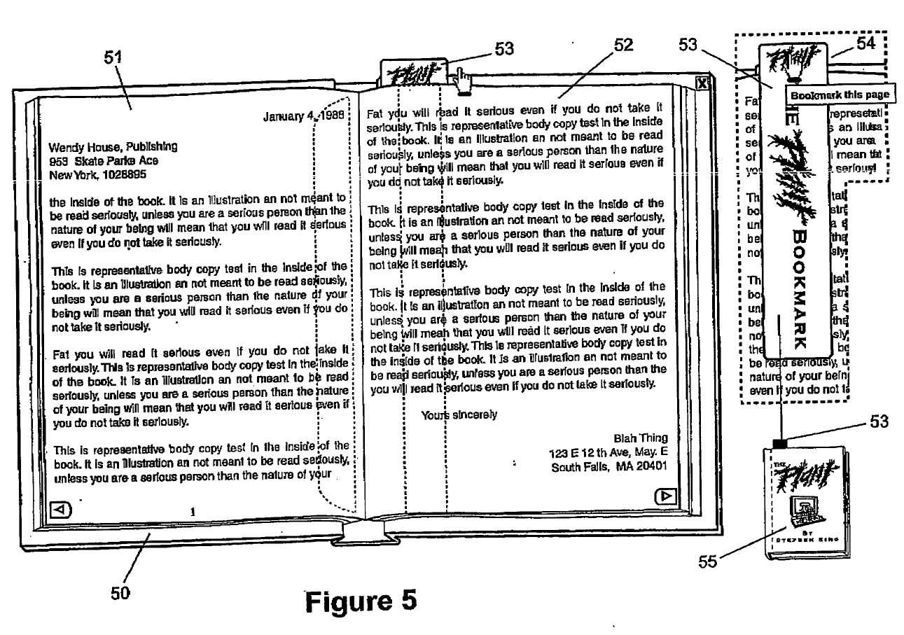

A book mark feature is also provided for the virtual books. In FIG. 4, a book mark top 43 is illustrated. Operation of the book mark will be described in relation to the embodiment of FIG. 5,

FIG. 5 illustrates a further embodiment of a virtual book 50. It is opened at pages 51 and 52 which the user requires to “book mark”. A virtual book mark 53 is shown in FIG. 5. Clicking on this moves the book mark 53 to the page 52 as indicated by reference numeral 54 and the book can then be closed (reference numeral 55) leaving the book mark 53 in place. The virtual book program can then be minimised or closed and when the user wishes to return to it, all they need to do is to click on the book mark 53 to turn to the last page that they read.

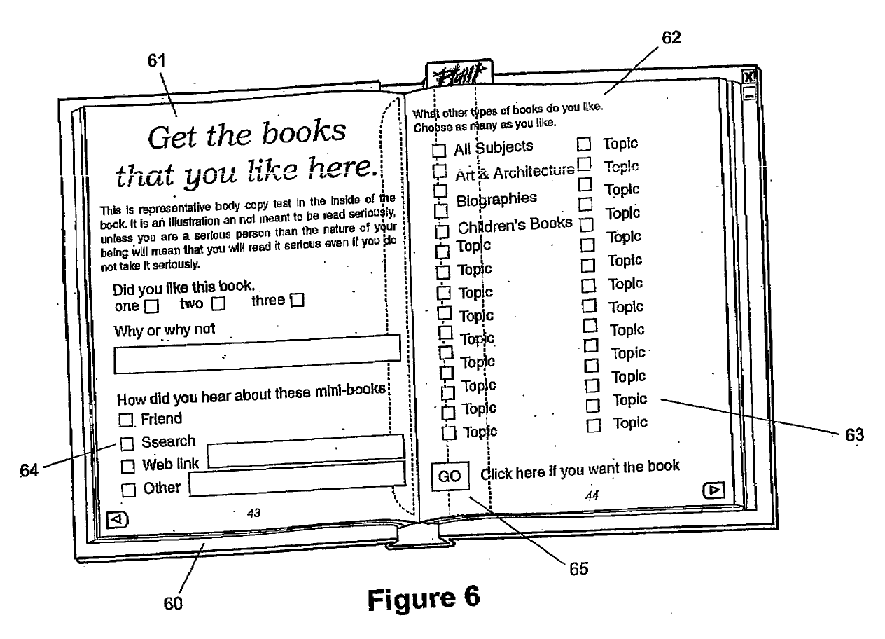

In preferred embodiments, links are also provided from the virtual books in accordance with the present invention to networks such as the Internet, and to various Web pages. These links are provided in various pages of the virtual books. FIG. 6 shows an example. A virtual book 60 opened at pages 61 and 62 which include interface means 63, 64 in the form of check boxes. A series of check boxes 63 relate to subject matter of various virtual books which may be ordered. Checking one of the boxes links to a web site listing the books in the particular category that has been checked, for further selection.

Check boxes 64 relate to a survey being carried out to obtain marketing information.

A further button 65 enables automatic ordering of the virtual book 60, or ordering of a real book corresponding to the virtual book 60. Clicking on the button 65 may link to a Web page of a book retailer e.g. Amazon.com™ and the user can then continue with the normal ordering process from the particular retailers site.

Alternatively, the book may be automatically ordered and paid for if credit card details (for example) have already been provided to the virtual book provider. This facilitates a process of marketing and selling virtual books in accordance with an embodiment of the present invention, as follows:

A user logs on to a virtual book providers Web site and downloads a virtual book “teaser”. This is a virtual book similar to those described in the above figures but does not include the entire contents of the book, merely a portion of the book as an introduction to the user of what the book is about and how it is written (maybe the first few pages would be provided as the teaser). If the user then wishes to purchase the book, they can click on a button such as button 65 and 66 and they may be given the choice of purchasing either a real book corresponding to the virtual took, or downloading the rest of the pages of the virtual took. This may be done for payment.

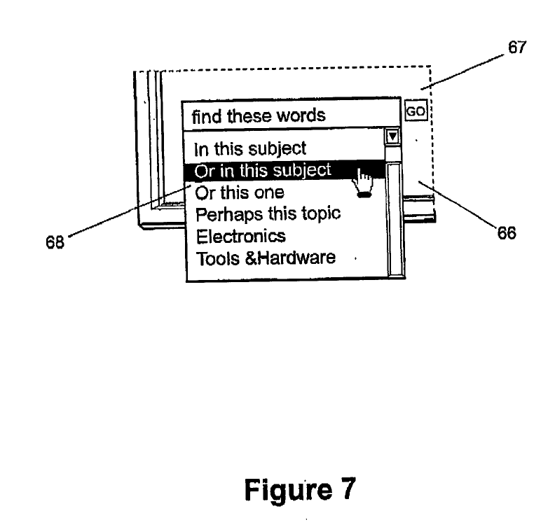

Pages of the virtual book in accordance with an embodiment of this invention may also include links to search functions. FIG. 7 shows a portion of a page 66 of a book which includes a link 67 to a search function for searching various categories 68.

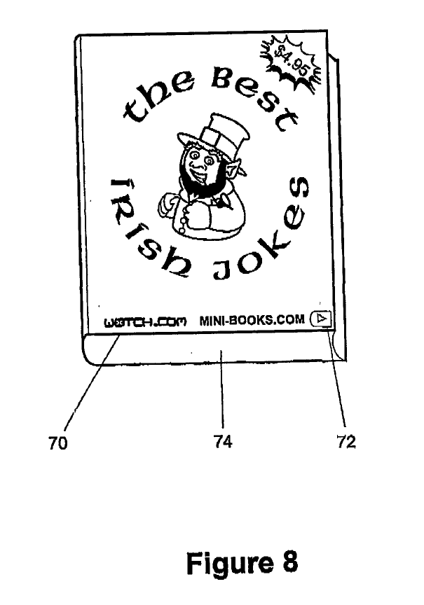

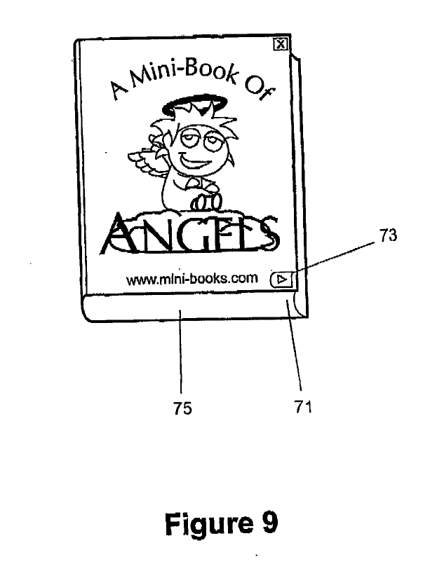

FIGS. 8 and 9 illustrate virtual books of a different format to the virtual books that have been described above. These virtual books 70, 71 do not included the “real-life” contouring which is shown in the books of FIGS. 1 to 7. It will be appreciated that other formats of books may be produced still falling within the scope of the present invention. The books 70 and 71 can be opened (by buttons 72 and 73) and have pages 74 and 75.

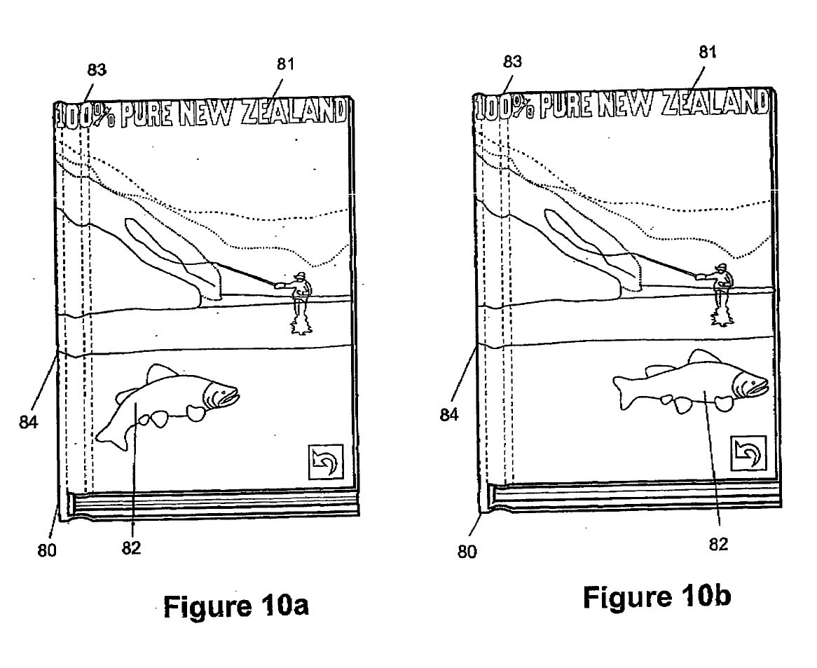

As well as images and printed matter, animation can also be included in the virtual books in accordance with embodiments of the present invention. FIG. 10 shows two views of the front cover 81 of virtual book 80. When appearing on the computer display, an animation sequence occurs on the cover 81 of the book 80. The fish 82 jumps from a “leftward” position in FIG. 10A to a position on the right of the cover 81 in FIG. 10B. Note that the cover 81 of the book 80 is a “real-life” cover including an image that conforms with contouring 83 particularly that of the spine 84 of the book 80.

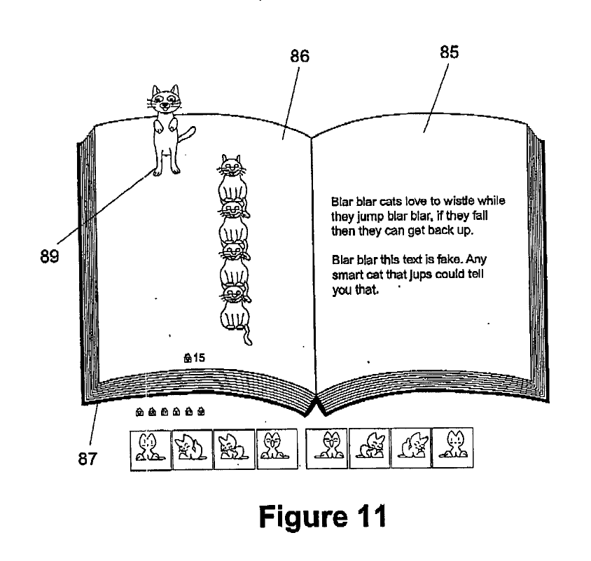

FIG. 11 illustrates open pages 85, 86 of a book 87 which is of a similar format to the books of FIG. 8 and FIG. 9 which is not so “real-life” and where the contours of the image and printed matter do not conform to any contours. This figure shows another example of animation. In this case the cat FIG. 29 can leave the page 86 and appear elsewhere on the computer display.

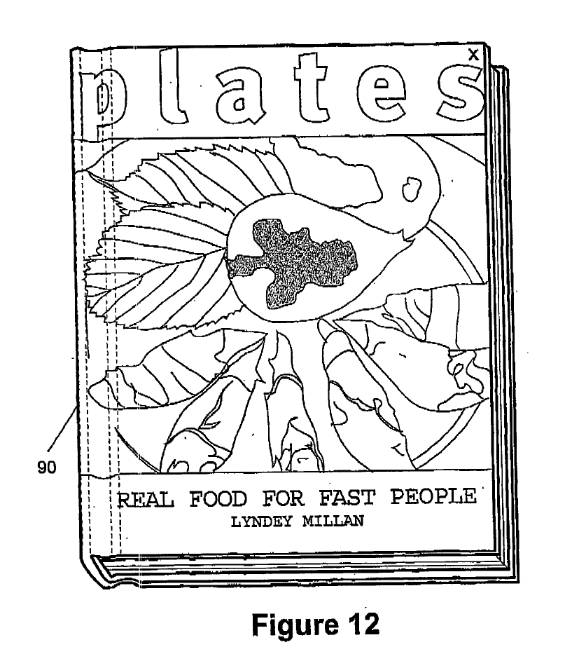

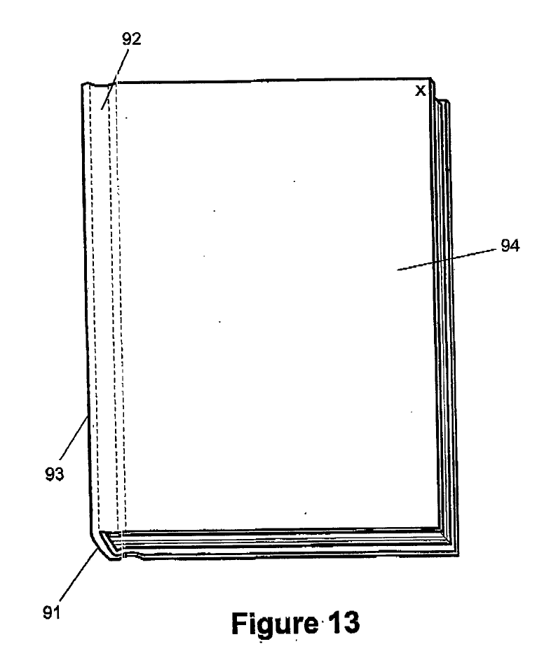

FIG. 12 shows an actual size virtual book 90. FIG. 13 shows a virtual book 91 clearly showing the “real-life” contouring 92, carried out by graphical shading, at the spine 93 of the book 91. The cover 94 of the book 91 is textured to enhance the “real-life” effect.

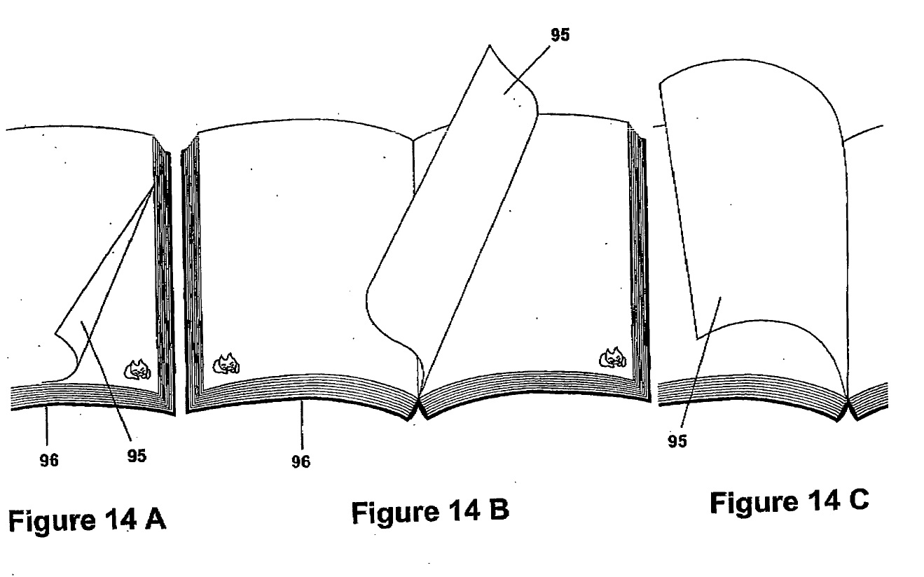

To further enhance the “real-life” effect, FIG. 14 illustrates how the page turning operation appears graphically, like the turning of a “real-life” page. FIG. 14A after clicking on the bottom right hand corner of the page 95 of book 96 (only a portion of which is shown in FIG. 14A) the virtual page 95 appears to roll over one corner as illustrated. FIG. 14B shows the “roll of the page 95” continuing and FIG. 14C shows the turn of the page 95 completing. It would be appreciated that the turning of the page does not have to occur exactly as shown in FIG. 14, but that, to enhance the real-life impression, turning in something like this manner is desirable.

To further enhance the impression of the turning of a real-life page, the virtual page may be arranged so that the text appears to distort as the page is turned.

Audio outputs may also be provided. These may be used to enhance the “real life” impression of the book—pages may “rustle” for example, or there may be provided audio indicators of an operation (e.g. button click). Audio output may also be associated with animation and images (e.g. the sound of water playing where the image of a river is presented to the user).

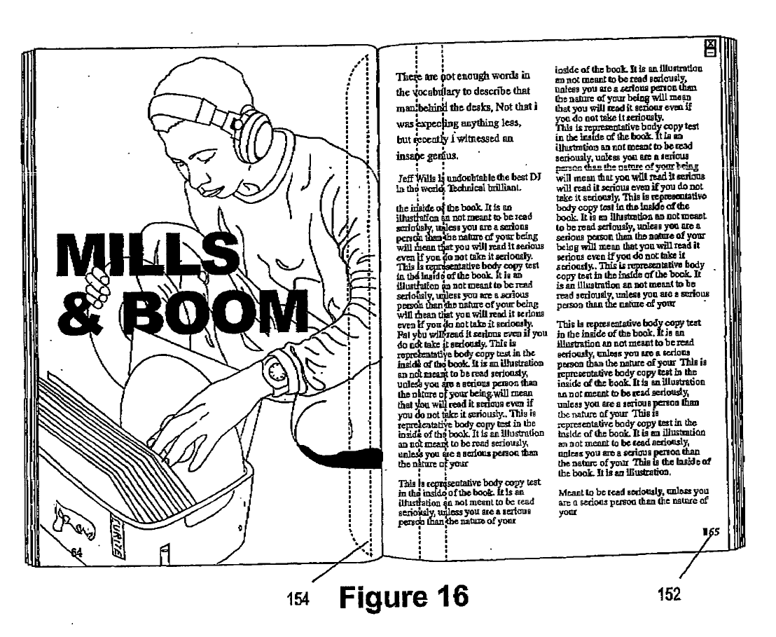

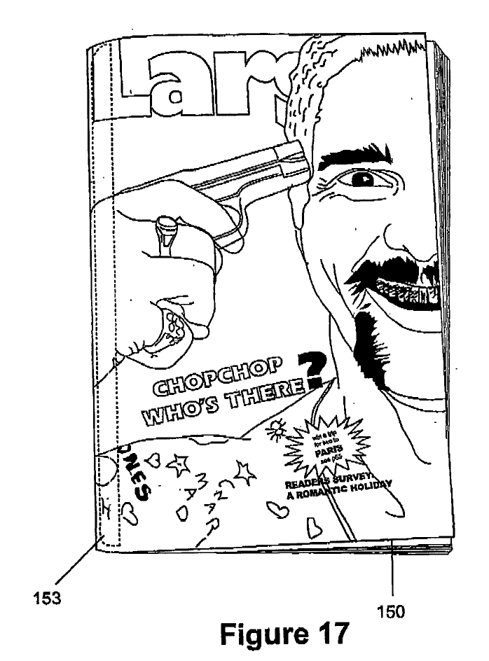

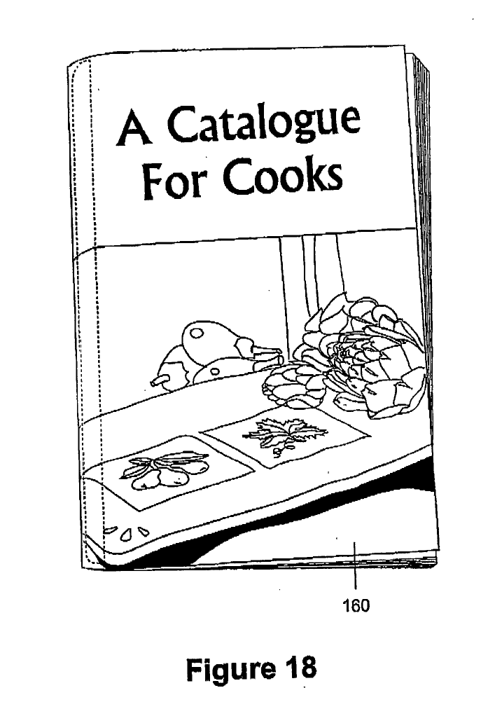

Referring to FIGS. 16 and 17, computer generated publication in the form of a virtual magazine 150 is illustrated. The magazine 150 includes interface means for opening the book and turning the pages (reference numerals 151, 152). The contouring 153, 154 is such as to create the impression of a soft-cover magazine-type publication.

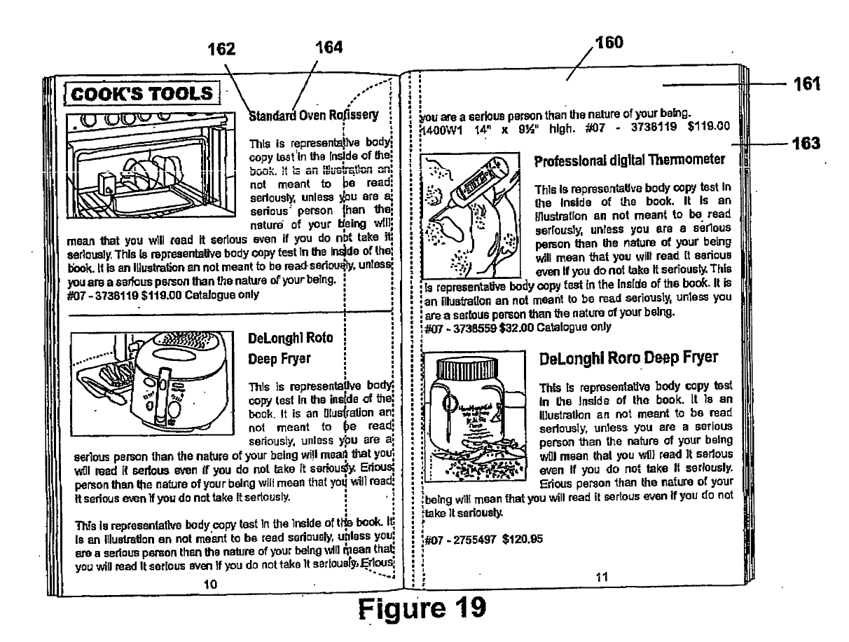

FIGS. 16 and 19 illustrate an embodiment of a computer publication in accordance with the present invention in the form of a virtual catalogue 160. The interface means are arranged so that each product described in the catalogue e.g. reference numerals 161, 162 are associated with links 163, 164, which, when executed, take the user to a Web page where the goods being advertised in the catalogue can be purchased.

As an alternative to the links 163, 164, it will be appreciated that an order form for a particular product could be associated with the catalogue and can be filled in by the user and then forwarded (e.g. by e-mail) to the product provider. Any other form of ordering could be used. A mouse click on a product image could automatically order the product for the user, for example.

The provision of virtual catalogues in this form is much less expensive than the printing and distribution of conventional catalogues.

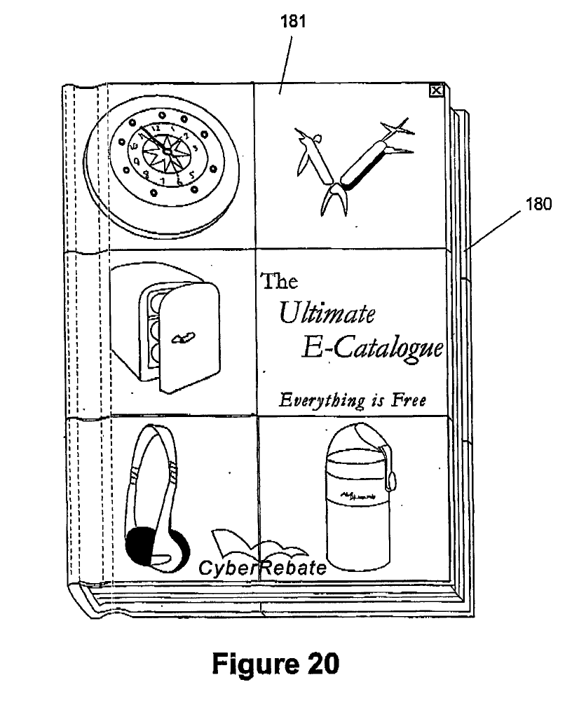

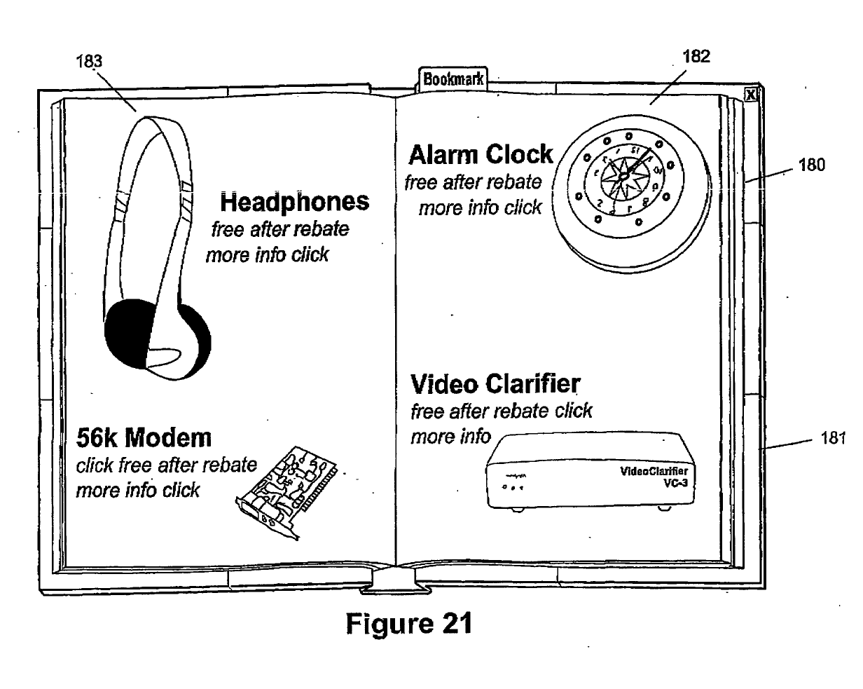

FIGS. 20 to 23 illustrate a further embodiment of a virtual catalogue 180 and show features of operation of the virtual catalogue 180. The virtual catalogue includes the catalogue cover 181. Open pages 182, 183 of the catalogue display products. A mouse “click” animates near the “free after rebate” button and then disappears. It animates to show the user where to click. “More info” is also a clickable button. When these buttons are selected book based pop-ups are launched.

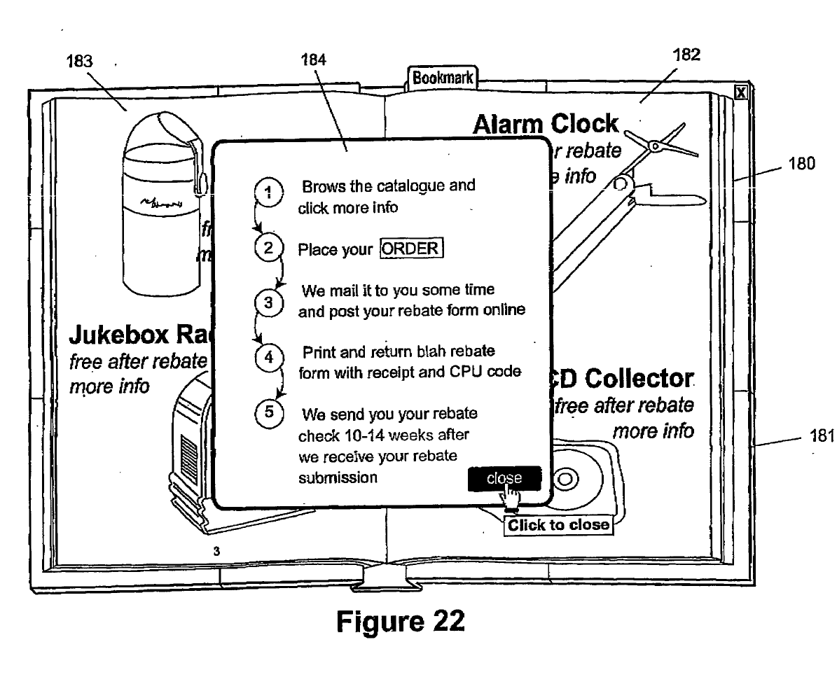

Referring to FIG. 22, the “more info” pop-up 184 informs the user how the rebate refund system operates.

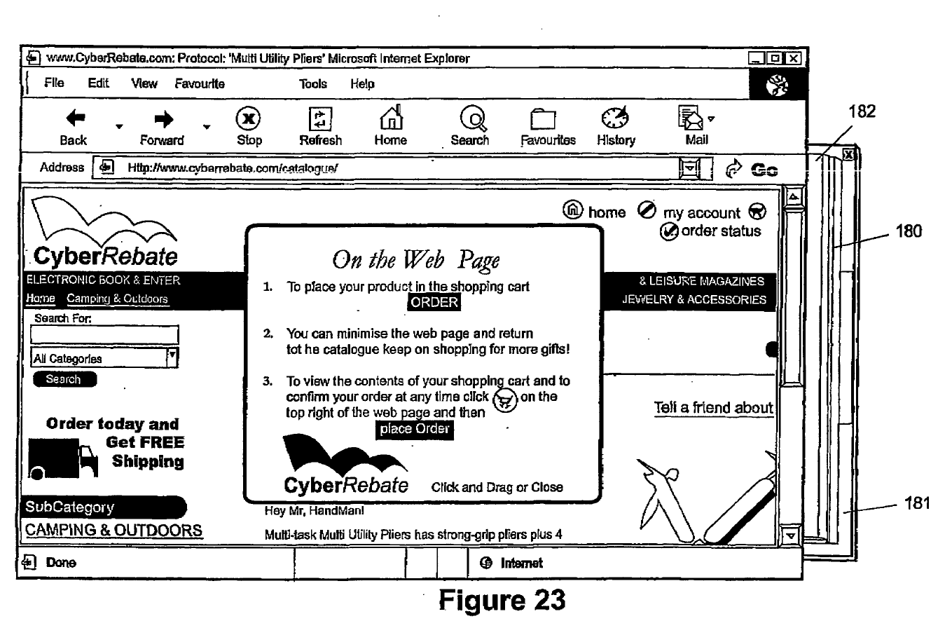

Referring to FIG. 23, the “free after rebate” button launches a top priority pop-up. This is a pop-up that will always remain above any other window. It instructs the: user on how to place an order on the rebate website. It also launches a web page with the product from the book. The book does not have priority and will be below the web page so that it does not obstruct using the web page. Ordering of product is therefore facilitated.

The present invention is not limited to virtual books, virtual catalogues or virtual magazines, as discussed above. Other virtual publications fall within the scope of the present invention, including; Post cards. Although post cards are single page, in accordance with an embodiment of the present invention they may be still moved about the desktop and turned around so that the back of the post card can be looked at; Virtual pamphlets. These may have pages or they nay be a single page folded, or just a single page, again they can be moved about the desktop and turned around with a three-dimensional effect;

Virtual newspapers;

Virtual periodicals;

Virtual calendars (with our without pages);

Virtual passports (with out without pages);

Virtual drivers licenses (and other identification cards);

Virtual CD covers;

Virtual files;

Virtual containers (e.g. cardboard boxes);

Virtual ring binders;

Virtual files containing single virtual pages which can be moved about the desktop.

Any other publication which can be represented in this way.

Note that, as discussed above, anything with multiple pages which appear bound together (including ring binders, calendars) fall within the definition of virtual book as given above.

With regards to virtual publications-which have a plurality of pages (i.e. virtual books), such as virtual magazines, virtual books, virtual catalogues, the pages will appear to be in “landscape” form. Generally, because of the low resolution of computer displays compared to the print media, the resolution of the pages of the virtual publication (e.g. the number of words on a page) will usually be less than that of a real book. As resolution improves, then this will change.

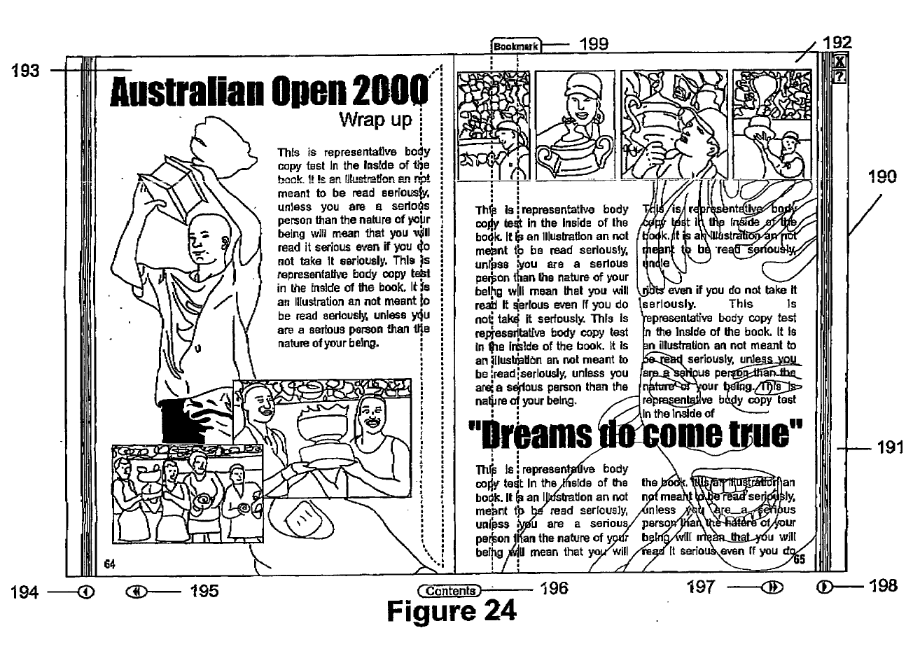

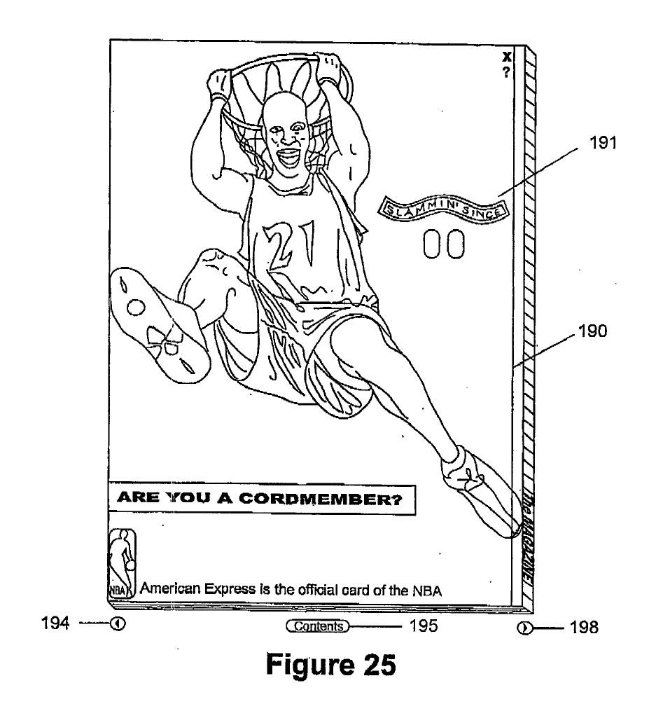

FIGS. 24 and 25 illustrate a virtual magazine 190.

The virtual magazine 190 has a cover 191, and when opened displays pages 192, 193. The magazine format is somewhat thinner than the virtual book format. It also includes external navigation buttons 194, 195, 196, 197, 198. As discussed above, any variation on an interface may be employed with the virtual publication of the present invention. The pages 193, 192 show multiple columns and also the bookmark 199 in the process of being used.

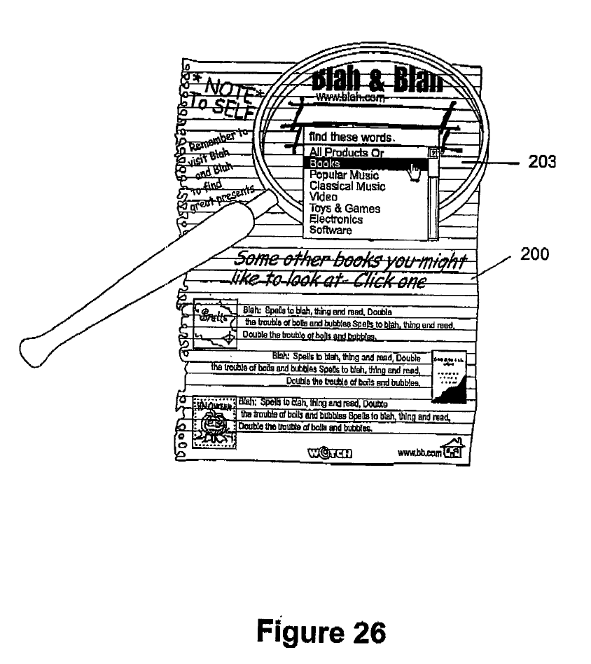

FIG. 26 illustrates another variation on the invention. In this embodiment, virtual paper is produced. The virtual paper 200 has the “look and feel” of a real piece of paper. In this embodiment it also has a drop down menu feature 201 showing a search capability.

It will be appreciated that many different types of interface for controlling the virtual publication may be utilised, we are not limited to button clicks or key strokes as discussed above. For example, a touch screen interface may be involved, or any other type of interface.

The computer generated publication is preferably generated by means including a software program which is arranged to execute on a computer such as the computer 1 in FIG. 1, in order to provide the virtual publication and interface. The software executable can be provided to the computer by transmission over a computer network, such as the Internet. In the preferred embodiment, the software for generating the computer generated publication may be obtained by ordering from a Web site on the Internet. The software preferably includes its own installation software, to install itself on the user computer 1 when it has been downloaded.

Any type of computing device may be used to play the virtual publication in accordance with the present invention. These may include palm-type computing devices, and readers way specially be designed to have a virtual publication in accordance with the present invention presented thereon. Electronic paper may be used to present a virtual publication in accordance with the present invention.

Note that it is not essential that the means for generating the computer generated publication be provided as an executable. It is possible that the computer generated publication could be accessed piece by piece over the Internet using a web browser.

Note that the virtual publication does not have to resemble a real publication in all respects. For a virtual book, for example, the minimum requirement of the present invention is that the book has virtual pages. The other requirements are preferable (e.g. covers being able to move the book in three-dimensions about the screen, etc) but not essential. For virtual publications that do not have pages (e.g. publications) it is essential that they resemble the real publication in at least that they can be moved about the screen and/or turned so that the back or front can be presented to the user.

In the above description, some of the embodiments of the virtual publication include animated features. GIF animation car also be supported, accompanying the animations with sounds. They can be loopable (definite or infinite) and they may also link to other actions e.g. links to the web.

Another improvement is the use of animation sequences for instructing people how to operate the virtual publication.

As well as the virtual publication, the present invention also provides a software tool for creating virtual publications. The software tool may be in the form of an editor for creating a virtual book, for example, and importing content into the virtual book.

Please note that where we have referred to the Internet in the above description and preamble and in the following claims, the Internet should be taken to include any public access network or an Intranet.

Where methods and apparatus of the present invention may be implemented by software applications, or partly implemented by software, then they may take the form of program code stored or available from computer readable media, such as CD-ROMS or any other machine readable media, the program code comprising instructions which, when loaded onto a machine such as a computer, the machine then becomes an apparatus for carrying out the invention. The computer readable media may include transmission media, such as cabling, fibre optics or any other form of transmission media.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The claims defining the invention are as follows:

1. A computer generated publication, comprising a virtual publication artefact generated by computer and presented on a computer display, the virtual publication artefact being arranged to resemble a real publication artefact, and publication interface means enabling manipulation of the virtual publication artefact in a manner representative of manipulation of the real publication artefact.

2. A computer generated publication in accordance with claim 1, when the virtual publication artefact is a virtual book, including virtual pages which appear on the computer display resembling pages of an actual book.

3. A computer generated publication in accordance with claim 2, the publication interface means including page turning interface means which enable the pages to be turned.

4. A computer generated publication in accordance with claim 3, the computer being arranged to display at least one full page of the virtual book at any time on the computer display.

5. A computer generated publication in accordance with claim 4, at least two full virtual pages of the virtual book being arranged to be displayed at any one time on the computer display.

6. A computer generated publication in accordance with claim 3, 4 or 5, the pages being arranged to turn in a manner which resemble the turning of pages in a real book, a portion of the page first rolling over and continuing to roll until the page turn is completed.

7. A computer generated publication in accordance with any one of claims 3 to 6, wherein the virtual pages are arranged to appear similar to the pages of a real book, having a three-dimensional look and feel and a three-dimensional contour, and wherein images or printed matter on the page are arranged to appear conforming with the contours.

8. A computer generated publication in accordance with any one of claims 2 to 7, the virtual book being arranged to have the look and feel of a three-dimensional book, and the publication interface means including means arranged to open the book and close the book.

9. A computer generated publication in accordance with claim 8, the interface means including means arranged to enable the book to be turned from the front to the back and also to show the spine of the book.

10. A computer generated publication in accordance with claim 8 or claim 9, images or printed matter on the cover being arranged to appear conforming with contours of the book cover.

11. A computer generated publication in accordance with claim 8, 9 or 10, the publication interface means including means enabling the user to move the virtual book about the computer display.

12. A computer generated publication in accordance with any one of claims 2 to 11, wherein the virtual pages included text, giving it the appearance of printed matter.

13. A computer generated publication in accordance with any one of claims 2 to 12, the virtual pages including images appearing on the pages.

14. A computer generated publication in accordance with claim 13, wherein the images are animated.

15. A computer generated publication in accordance with any one of claims 2 to 14, wherein audio output is associated with manipulation of the virtual book.

16. A computer generated publication in accordance with claim 15, wherein the audio output is associated with the contents of the book.

17. A computer generated publication in accordance with claim 14, 15 or 16, wherein animated images may appear to leave the virtual book and go elsewhere on the computer display.

18. A computer generated publication in accordance with any one of claims 2 to 17, including a virtual bookmark, the virtual bookmark being arranged to be manipulated by the publication interface means to mark a page in the book which the user may wish to return to at a later stage.

19. A computer generated publication in accordance with any one of claims 2 to 18, the virtual book including an index and the virtual publication interface including link means that enables a link between any item in the index and the virtual page where that item appears in the book.

20. A computer generated publication in accordance with claim 19, wherein the publication interface means includes a link on each page which enables the user to return to the index.

21. A virtual publication in accordance with any one of the preceding claims, the publication interface means including a link interface for linking to other locations on a computer network, such at the Internet.

22. A computer generated publication in accordance with any one of claims 2 to 21, the publication interface means including a means which enables the user to download the books total contents for payment or to order a real book resembling the virtual book.

23. A computer generated publication in accordance with any one of the preceding claims, the publication interface means including links to Web based search engines to enable searches to be carried out from the publication.

24. A computer generated publication in accordance with any one of the preceding claims, including means restricting operation of the publication to a predetermined computing device, whereby the publication may not be copied without authorisation to run on another computing device.

25. A computer generated publication in accordance with any one of the preceding claims, wherein the virtual publication artefact may contain links to other documents and programs on the computing device on which the virtual publication artefact is being presented.

26. A computer generated publication in accordance with any one of claims 2 to 26, the user being able to read at least one full page of the virtual book without needing to scroll the page.

27. A computer generated publication in accordance with any one of the preceding claims, the virtual publication artefact being generated from an executable program on the computer.

28. A computer generated publication in accordance with any one of the claims 1 to 26, the virtual publication artefact being generated by a user browser accessing a link over the Internet.

29. A computer generated publication in accordance with claim 27 or 28, the virtual publication artefact being generated as a window on the computer display.

30. A computer generated publication in accordance with claim 29, wherein the window is irregularly shaped.

31. A computer generated publication in accordance with any one of claims 2 to 30, being in the form of a “teaser” comprising part of a total publication.

32. A computer generated publication in accordance with any one of claims 2 to 31, wherein the virtual book is a virtual catalogue, containing information on products for purchase.

33. A computer generated publication in accordance with claim 32, including means enabling purchase of products from the catalogue.

34. A computer generated publication in accordance with claim 33, the means enabling purchase including links to Internet sites where products included in the virtual catalogue may be purchased.

35. A computer generated publication in accordance with claim 1, being a virtual postcard, or virtual CD, or virtual periodical, or virtual file, or virtual container.

36. A virtual publication in accordance with claim 35, the virtual publication artefact being manipulatable about the desktop in a similar manner to a three-dimensional article.

37. A computing system including means arranged to generate a virtual publication artefact in accordance with any one of the preceding claims.

38. A computing system in accordance with claim 37, comprising a palm-type computing device.

39. A computing system in accordance with claim 38, wherein the palm-type computing device is a dedicated reader.

40. A computing system in accordance with claim 38 or 39, wherein the palm-type device includes electronic paper.

41. A computer readable medium, including instructions for controlling a computing system to generate a virtual publication artefact in accordance with any one of claims 1 to 35.

42. A method of providing published material via a computer, the method comprising the steps of generating by computer a computer generated publication in accordance with any one of claims 1 to 35.

43. A computing system, including a virtual publication tool for creating a computer generated publication in accordance with any one of claims 1 to 35.

44. A computer readable medium, including instructions for controlling a computing system to provide a virtual publication tool for creating a computer generated publication in accordance with any one of claims 1 to 35.

45. A method of distributing information on products for sale to users, comprising the steps of distributing a virtual publication including content providing information on the products for sale, via a computer network to user terminals.

46. A method in accordance with claim 45, wherein the virtual publication is a downloadable executable.

47. A method in accordance with claim 45 or claim 46, wherein the virtual publication is a virtual publication in accordance with claim 32.

48. A method in accordance with claim 47, further comprising the step of enabling users to order products over the network utilising the virtual publication.

49. A virtual publication distributable to users computers and comprising an executable program, wherein the content of a virtual publication and the virtual publication are provided by the same executable program.

50. A virtual publication in accordance with claim 49, wherein the virtual publication is a computer generated publication in accordance with any one of claims 1 to 35.

51. A method of disseminating information comprising the steps of providing a plurality of virtual publications in the form of executables, downloadable via a computer network or distributable via a computer readable media, each executable including the information content and data enabling the information content to be read in the form of a virtual publication, in the single executable.

52. A methods in accordance with claim 51, wherein the virtual publication is a computer generated publication in accordance with any one of claims 1 to 35.
